(19) United States
(12) Patent Application Publication
(10) Pub. No.: US 2007/0239362 A1
(43) Pub. Date: Oct. 11, 2007

(54) Fictitious play based assembly sequence optimization considering process constraints

(75) Inventors: Daniel J. Reaume, Livonia, MI (US); Wayne W. Cai, Troy, MI (US); Jeffrey M. Alden, Ypsilanti, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/696,905

(22) Filed: Apr. 5, 2007

Related U.S. Application Data
(60) Provisional application No. 60/790,609, filed on Apr. 10, 2006.

(51) Int. Cl. G06F 19/00

(52) U.S. Cl. 702/19

(57) ABSTRACT

A method for optimizing a sequence of things that employs a fictitious play algorithm. The method includes assigning an agent to each thing in the sequence, and defining an objective function that is a function of certain performance indices of the things. The method also includes determining an initial sequence of the things, and defining a random sample of a plurality of past sequence of the things. The method then sequentially and independently selects an optimal position for each thing in the sequence that minimizes the objective function relative to the sampled sequences. The method then determines a new sequence of the things based on the selected positions of the things in the sequence, and then determines whether the new sequence is closer to optimal than the previous sequences of the things.

### CROSS REFERENCE TO RELATED APPLICATIONS

This application claims priority to U.S. Provisional Application Ser. No. 60/790,609, filed Apr. 10, 2006, titled “Fictitious Play Based Assembly Sequence Optimization Considering Process Constraints”.

### BACKGROUND OF THE INVENTION

1. Field of the Invention

This invention relates generally to a method for providing sequence optimization and, more particularly, to a method for providing assembly sequence optimization using a fictitious play algorithm.

2. Discussion of the Related Art

Sheet panels are widely used in automotive assembly. Individual panels are joined and assembled through a variety of processes, such as welding, bonding and riveting, progressively into sub-assemblies, such as an inner door panel with reinforcement, major assemblies, such as a complete door system, and ultimately a body-in-white with closure panels. Appropriate assembly sequence designs can improve vehicle dimensional quality, optimize cycle time and reduce cost.

It is known that different assembly sequences can result in different assembly dimensional variations. To illustrate this, FIG. 1 shows an assembly 10 that includes three parts 12, 14 and 16 assembled together with one butt joint 18 and one slip joint 20. To assemble the parts 12-16, two different assembly sequences can be performed. Particularly, a first sequence includes assembling part 12 to part 14, and then assembling the combination of parts 12 and 14 to part 16. A second sequence includes assembling part 16 to part 14, and then assembling the combined part 14 and 16 to part 12.

Tolerance analysis shows that the total assembly dimensional variation for the first sequence is zero and the total dimensional variation for the second sequence is equal to that of the part 12. This is based on the assumption that the slip joint 20 between the parts 14 and 16 can absorb variations while the butt joint 18 between the parts 12 and 14 can only propagate variations. Particularly, because each part 12-16 will have some variations in length, and the total assembly of the parts 12-16 will have some variation, it would be better to first assemble part 12 to part 14, and then assemble part 16 to part 14 to achieve a desired overall length tolerance because the slip joint 20 can be used to adjust the length of the complete assembly.

Traditionally, assembly sequence planning is experience-based guesswork, lacking scientific reasoning and engineering precision. For example, one approach, referred to as bill of process (BOP), dictates the assembly sequence. For new vehicle programs, experienced process engineers would gather together to decide the new BOP, including the assembly sequences, based largely on what is perceived as practical or the appropriate thing to do. Further, genetic algorithms are known in the art for determining assembly sequences, but suffer a number of disadvantages in their optimization rate and their ultimate efficiency. Because a typical assembly sequence includes a lot of constraints, such as one part needs to be assembled before another part, and because there are many different combinations of parts, the assembly sequence designs need to be optimized to produce the best tolerances.

### SUMMARY OF THE INVENTION

In accordance with the teachings of the present invention, a method for optimizing a sequence of things, for example, a parts assembly sequence, is disclosed that employs a fictitious play algorithm. The method includes assigning an agent to each thing in the sequence, and defining an objective function that is a function of certain performance indices of the things. The method includes determining an initial sequence of the things, and defining a random sample of a plurality of past sequence of the things. The method then sequentially and independently selects an optimal position for each thing in the sampled sequences that minimizes the objective function relative to the sampled sequences. The method then determines a new sequence of the things based on the selected positions of the things in the sequence, and then determines whether the new sequence is closer to optimal than the previous sequences of the things. If the optimal sequence is infeasible, then the method employs a feasibility algorithm to make the sequence feasible. In one embodiment, the feasibility algorithm employs matrices and graph theory to identify constraints in the sequence.

Additional features of the present invention will become apparent from the following description and appended claims taken in conjunction with the accompanying drawings.

### BRIEF DESCRIPTION OF THE DRAWINGS

FIG. 1 is a plan view of three assembled parts;

FIGS. 2(A) and 2(B) are flow chart diagrams showing an algorithm for optimizing an assembly sequence using a fictitious play algorithm, according to an embodiment of the present invention;

FIG. 3 is a graph illustrating precedence constraints for a method for optimizing an assembly sequence, according to an embodiment of the present invention; and

FIGS. 4(A) and 4(B) are a flow chart diagram showing an algorithm for changing an infeasible assembly sequence to a feasible assembly sequence, according to an embodiment of the present invention.

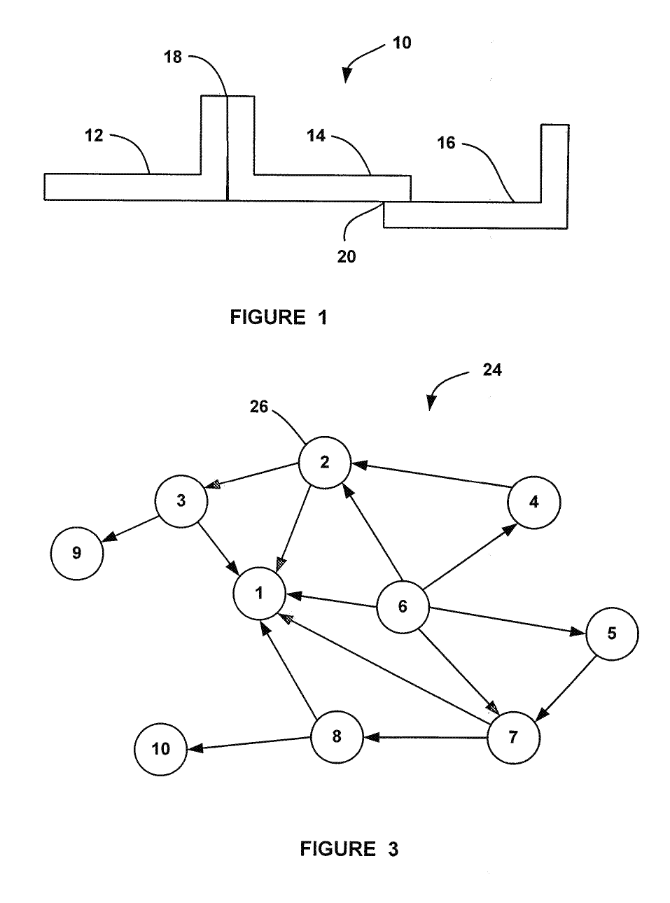

### DETAILED DESCRIPTION OF THE EMBODIMENTS

The following discussion of the embodiments of the invention directed to a method for optimizing an assembly sequence using a fictitious play algorithm is merely exemplary in nature, and is in no way intended to limit the invention or its applications or uses. For example, the fictitious play algorithm of the invention has particular application for optimizing an assembly sequence. However, in alternate embodiments, the fictitious play algorithm of the invention can be used to optimize other sequences, processes and things.

Once aspect of the invention includes optimizing a sequence. However, as is appreciated by those skilled in the art, for virtually all complex, non-linear and combinatoric optimization problems, the standard practice is too to solve the problem to be nearly optimal, as a truly optimal solution would be intractable and the additional benefits would be negligible. Therefore, as used herein, the term optimal is intended to mean optimal and nearly optimal.

To address the assembly sequence optimization problem discussed above, it has been proposed to use the following optimization process to determine a best assembly sequence. The optimization process includes minimizing an objective function f defined as a tolerance output for key dimensions, which may be subject to process constraints including, but not limited to:
(a) part i must be before/after part j;
(b) part i can never be before/after j;
(c) part i can never be immediately before/after
(d) part i, j must/must not be in sequence
(tandem/anti-tandem, respectively);
(e) if part i is assembled before j, then part k must/must not be assembled before part m; and
(b) a certain sequence is simply not feasible.

This is a very difficult combinatoric optimization problem because the number of potential assembly sequences grows exponentially with the number of parts to be assembled. Moreover, the objective functions and the constraints may be quite complex and will generally not have the appropriate structure required by typical optimization algorithms, such as branch-and-bound type algorithms.

According to the invention, a fictitious play algorithm is employed to solve the assembly sequence problem using a game-theoretic approach where each part is represented by an intelligent agent that repeatedly plays a game with other agents by choosing its position in an assembly sequence, where the goal of the game is to devise the best assembly sequence for all of the parts. As is well understood in the art, fictitious play is an interactive procedure applied to a finite non-cooperative situation in which each of the players is faced with selecting a strategy from a finite set of available strategies.

In the discussion below, the objective function f denotes some function of one or more variations in key dimensions. For example, the objective function f might represent the maximum variation, the sum of variations, or a weighted average of variations. The variable N denotes the number of parts to be assembled, where the parts are labeled 1, 2, . . . , N. Each part i is assigned a decision agent whose decision is to determine the position of the part in the sequence, i.e., where the part should be assembled. For example, if part i is the fourth part to be assembled, then the decision of agent i is 4. A joint set of decisions for all agents is used to represent an assembly sequence policy, or just policy p. For example, if there are five parts to be assembled, p=(1, 2, 3, 4, 5) and p=(3, 2, 1, 4, 5) are two possible sequence policies. The function R(p,n,x) represents the policy obtained by reordering a sequence policy p by removing part n from the sequence, and reinserting part n in the sequence so that it is now the xth part in the sequence. For example, if p=(1, 2, 3, 4, 5), R(p,2, 4)=(1, 3, 4, 2, 5) because part 2 is shifted to the fourth position in the modified sequence.

Suppose the optimization problem involves M constraints. These will pose a challenge to the optimization algorithm because, given several sequences, there may be no single position for a particular part 1 that is feasible for each sequence. For example, suppose one constraint is that part 2 must be assembled after part 1, but before part 3. If there are only two available sequences (1, 3, 4, 5, 6) and (4, 5, 6, 1, 3), then there is no single position for part 2 that is feasible in both sequences.

To deal with such issues, penalties are applied for violating feasibility. The function gₘ denotes a penalty function for violating constraint #m. Generally, the penalty function gₘ should be chosen so that gₘ(p)=0 if policy p satisfies constraint #m and gₘ(p) equals a value that significantly outweighs any potential value of a feasible solution if policy p violates constraint #m. These penalties ensure that an infeasible part position is significantly penalized. For example, the penalty function gₘ(p) might be set to a value ten times the maximum possible feasible value of the objective function f if policy p violates constraint #m. Note that it may be that the objective functions is unevaluateable for a given infeasible sequence. In such cases, its value could be defined to be equal to 0, because a penalty for the function gₘ will dominate it in those cases.

Let the function h represent an augmented objection function consisting of the sum of the objective functions plus all of the penalty functions gₘ, where:

$$h ( p ) = f ( p ) + {\sum }_{i - 1}^{M} {g}_{m} ( p ) \qquad ( 1 )$$

If the particular policy p is feasible, then the objective function h(p) will equal f(p). If, however, the particular policy p is infeasible, then the objective function h(p) will exceed f(p). In this case, the objective function h will include a large penalty component. Therefore, since the objective functions is trying to be minimized, the function h will invalidate the infeasible policies p as a result of the large penalty.

Let the function q(x) denote a deterministic function that specifies a random sample size as a function of the iteration number x. Typical examples include q(x)=a and q(x)=x^{a} for some constant a. Also, let the best augmented objective value observed through the current iteration of a fictitious play algorithm be h* and the corresponding policy be p* i.e., h(p*)=h*.

According to the invention, a fictitious play algorithm is used to determine an optimum sequence, such as an assembly sequence, based on the variables set forth above. In a fictitious play process, each variable in the problem is modeled as an agent, where the particular agents are viewed as players in a game. All of the players in the game have a common objective, particularly to minimize the objective function f by developing optimal policies p. Each agent decides its position in the policy p. The agents do not share information in that they do not decide jointly where the best position for each agent is, but each agent individually decides its best position based on a sample of previous history. For example, a particular agent would determine its position based on past probabilities of what the other agents in the game selected as their position in earlier iterations. Once all of the agents have selected their position based on previous information, the positions of all of the agents together define a new policy, potentially requiring tie-breaking if multiple agents select the same position. The process goes through a number of iterations to generate better and more feasible solutions.

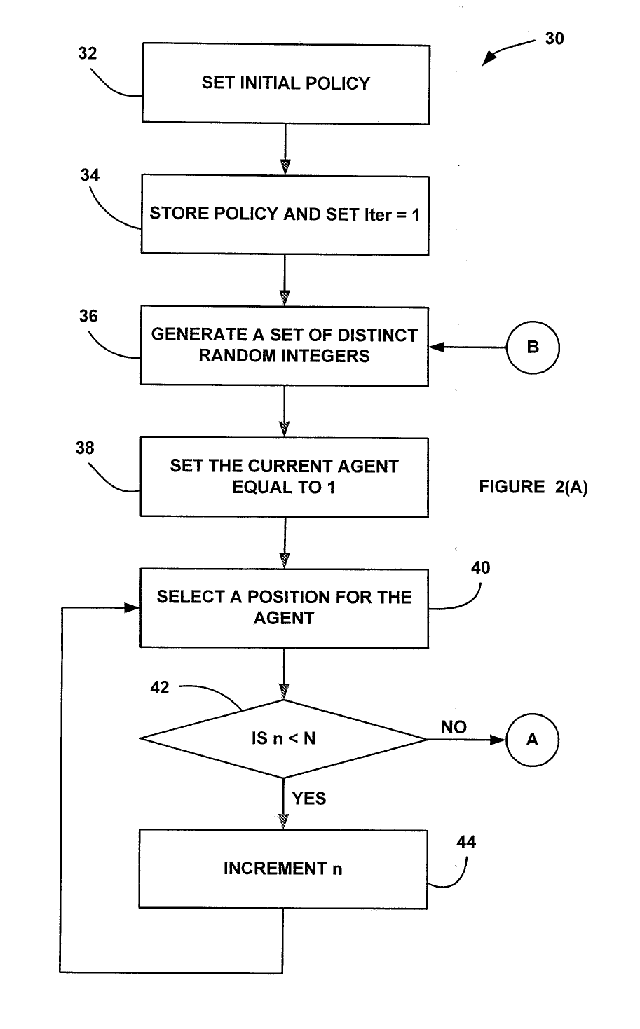

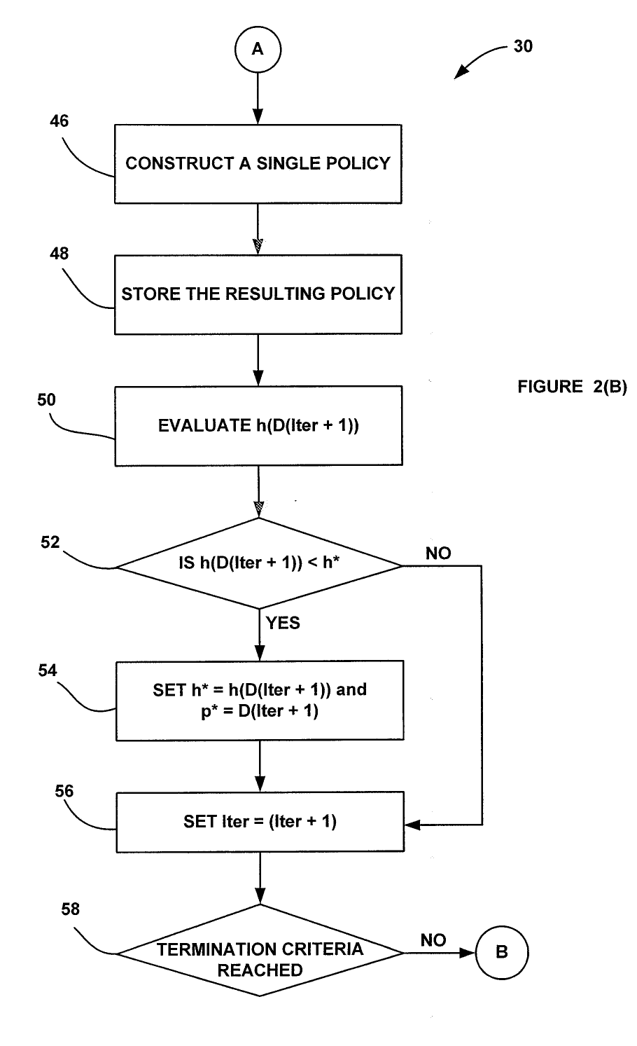

FIGS. 2(A)-2(B) are a flow chart diagram 30 showing a process for a fictitious play algorithm for determining an assembly sequence using fictitious play, according to an embodiment of the present invention. The algorithm begins with an initial “reasonably good” assembly sequence policy p at box 32. The algorithm stores this policy p in position #1 in a database D calling it D(1) and sets Iter=1 at box 34. Next, the algorithm generates a set (s(1), . . . , s(q(Iter))) of q(Iter) distinct random integers uniformly distributed between 1 and Iter at box 36. This step defines a random sample of past policies from the database D to be used. Depending on the number of samples of past policies, the algorithm will select a reasonable number of these past policies for the random sample. Of the past policies, each policy p will have an equal chance of being the policy that will be picked. Next, the algorithm sets the current agent n equal to 1 at box 38.

The algorithm then selects a position p(n) for agent n at box 40 that minimizes the function:

$$\frac{1}{q ( Iter )} {\sum }_{i = 1}^{q ( Iter )} h ( R ( D ( s ( i ) ) , n , p ( n ) ) ) \qquad ( 2 )$$

In other words, the algorithm finds the position that is a “best response” for part #n to optimize the expected value of the augmented objective function h if all of the other parts are equally likely to choose their collective positions from one of the sequences D(s(1)), D(s(2)), . . . , D(s(q(Iter))). For example, if q(Iter)=2, D(s(1))=(3,2,1,4,5) and D(s(2))=(4,2,5,3,1), then the agent n corresponding to part I would assign the value of (½)(h(1, 3, 2, 4, 5)+h((1, 4, 2, 5, 3)) as the value of selecting position #1 for its part. Since the number of possible position choices for each agent n is not great, being bounded by N, total enumeration can be used for this local optimization. Note, that this step is where the penalty functions are required, since it may be the case that no single position is feasible for a part in all sampled policies. However, the invention provides another enhancement without penalty functions, discussed below, to circumvent this problem.

The algorithm then determines if n<N at decision diamond 42 to determine it a position has been selected for every agent. If n is less than N at the decision diamond 42, then the algorithm increments n at box 44 and returns to the box 40 to select an optimal position for the next part in response to the randomly sampled set of assembly sequence policies. This process continues until positions for all of the agents have been selected, where n is equal to N.

Next, the algorithm constructs a single policy D(Iter+1) from the individual agent positions at box 46 generated in the step of the box 40. This is accomplished by ordering the parts according to the positions specified by their individual decisions. The resulting policy p is stored in the database D in position #Iter+1 at box 48 as a “synthetic policy”. For example, if the agents n for parts 1, . . . , 5 selected positions 4,3,1,2, and 5, respectively, then the corresponding synthetic policy is (3, 4, 2, 1, 5).

Because agents make their decisions independently, it is possible that several agents n will select the same position. Since there can only be a single part i in a given position in the assembly sequence, such conflicts should be resolved. This can be done by randomly ordering the parts whose agents n selected the same position to yield a sub-sequence to be inserted at the contested position. For example, suppose the agents for parts 1, . . . ,5 selected positions 3, 4, 3, 2, and 5, respectively. The associated assembly sequence is (?,4, 1&3, 2, 5) because no agent n selected the first position and agents 1 and 3 both selected position 3. Because agents 1 and 3 both selected position 3, the two possible sequences to insert in position 3 are (1,3) and (3,1). Therefore, with equal probability the synthetic policy would be (4, 1, 3, 2, 5) and (4, 3, 1, 2, 5). In this case, since no agent n selected position 1, the sequence simply shifts forward one position. The sequence can be shifted in any appropriate direction to fill those spots that were not originally selected by the agents since the shift does not impact relative positions in the sequence.

The algorithm then evaluates h(D(Iter+1)) at box 50. If the value is less than h* decision diamond 52, then the algorithm sets h*=h(D(Iter+1)) and sets p*=D(Iter+1)) at box 54, otherwise, the algorithm sets Iter=Iter+1 at box 56. The previous best value was h*, so that if the current value is less than h*, meaning that it is closer to the minimum value, then a new h* is set accordingly. The algorithm then sets Iter=Iter+1 at the box 56. The algorithm determines if an iteration limit or other termination criterion has been met at box 58, for example, no change in h* over a certain number of iterations has happened. If not, the algorithm goes back to the step of box 36.

Application of the fictitious play algorithm discussed above is not straightforward because the synthetic policies generated at the box 46 may not be feasible, even though the penalty functions gₘ tend to encourage feasibility or near-feasibility. To convert an infeasible assembly sequence into a feasible assembly sequence, while retaining as much of the sequence structure as possible, a feasibility algorithm, discussed below, may be used, according to the invention. Note that the feasibility algorithm addresses only precedence type constraints, such as constraints (a), (b) and (c). Other algorithms may be applied for different types of constraints.

The manner in which the feasibility algorithm works is by representing the precedence constraints as a mathematical construct referred to as a directed graph. FIG. 3 illustrates such a graph 24, where each part corresponds to a node 26 in the graph 24, and a constraint that part i must precede part j would be reflected by an arc from node i to node j. As shown, part 9 must be assembled after part 3. Indirectly, the graph 24 also implies that part 9 must be assembled sometime after part 2 because part 3 must be assembled after part 2. If the precedence constraints allow a feasible assembly sequence, the resulting graph cannot contain any cycles, i.e., if part must precede part j, then part j cannot be required to precede part i.

Many results from graph theory may be applied to derive information from the graph. In particular, before applying the feasibility algorithm, a matrix M is generated where the (i,j)th entry of matrix M is equal to 1 only if there is a constraint that part i must be assembled after part j, and is equal to 0 otherwise. Note that the number of 1's in the matrix equals the number of arcs in the graph. The procedure for generating a matrix of nodes in a graph of the type shown in FIG. 3 is well known to those skilled in the art. Referring to the graph 24, for example, entry (3,2) in M would equal 1 because part 3 must be assembled after part 2, but entry (9,1) of M would equal 0 because there is no precedence constraint between these nodes. Using standard matrix multiplication, M², M³, M⁴, . . . , M^{N-1} can be computed. Note that if M^{k}=0, then there is no need to compute further matrices, as they will all be 0.

A basic result of graph theory states that matrix M^{k} will contain a 1 in entry (i,j) only if the graph implies a constraint that part i must be assembled after part j, and at least (k−1) other intermediate parts. For example, entry (9,2) of M² would be equal to 1 because node 9 must be assembled after node 3, which must be assembled after node 2. Note that constraints of type (c) may be represented in this context by a simple precedence constraint by adding a “dummy” part i that must be assembled between two parts j and k. By searching each matrix Mt to see if at least one contains a 1 in entry (i,j), it can be quickly determined whether part i must be assembled directly or indirectly after part j.

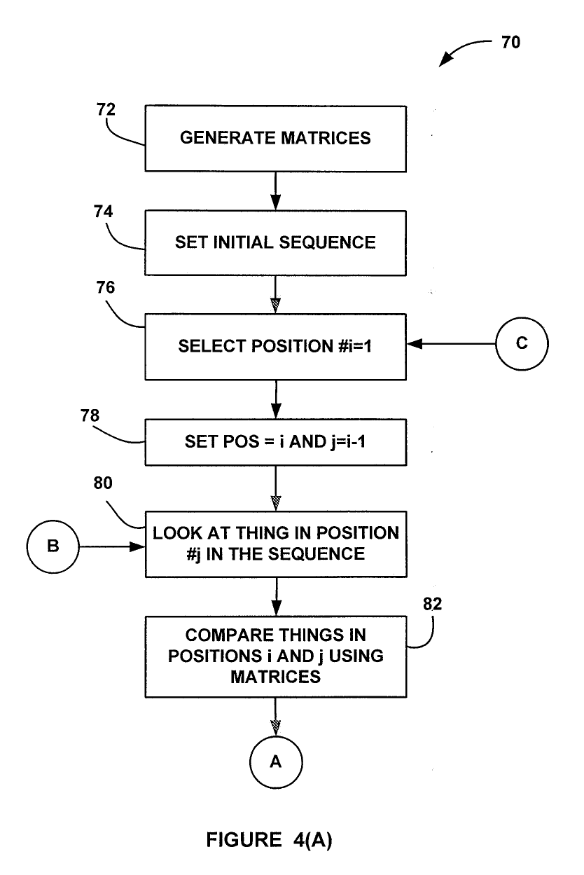

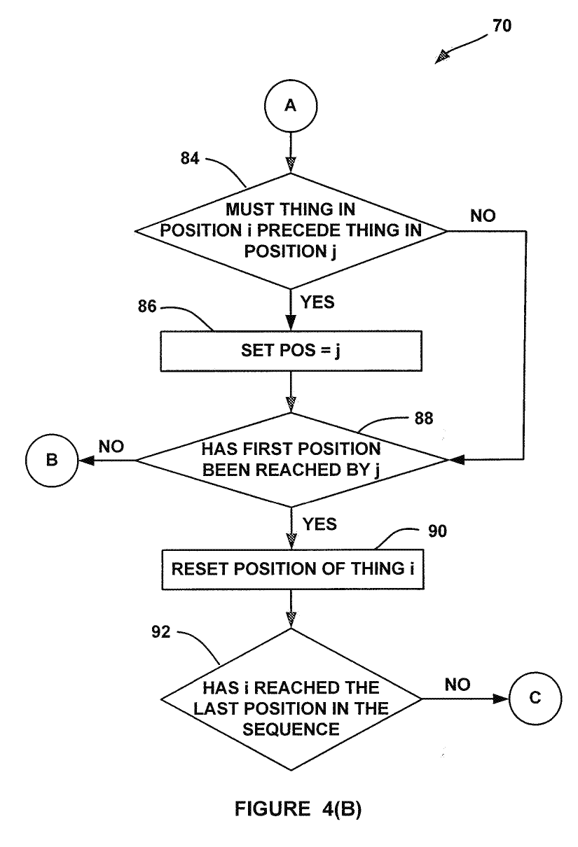

FIGS. 4(A) and 4(B) are a flow chart diagram 70 showing the operation of the feasibility algorithm, according to an embodiment of the invention. For the feasibility algorithm, p(i) denotes the part # currently in position i in the sequence. The algorithm generates matrices M¹, M², M³, M⁴, . . . , M^{N-1} at box 72 based on the discussion above. Note, that this must be done only once for a given set of precedence constraints. As discussed above, if an entry in the matrix is a 1, then the corresponding constraint is present, for example, part i must be assembled before part j. By squaring the matrix M by conventional matrix multiplication, the multiplication will show indirect constraints in that one part needs to precede another part in the sequence with a third part in between. By cubing matrix M, the algorithm is able to tell if a part precedes another part, and whether two other parts need to be between those parts, and so forth. The resulting matrices may be applied many times to many different sequences.

The algorithm then sets an initial sequence p at box 74, which may be, for example, a final sequence (feasible or infeasible) from the fictitious play algorithm at the box 56. The algorithm then determines the current position being evaluated at box 76. For example, the first time through the process the algorithm will select the second position in the sequence as position i. The algorithm will then set pos=i and j=i−1 at box 78. The algorithm then looks at the preceding part in the sequence relative to the current part being evaluated at box 80, such as position #j. For the first time through, the algorithm is only looking at the first part in the sequence.

The algorithm then determines if the current part at the current position must be assembled before the part at the previous position at box 82 using the matrices M as discussed above. For example, the algorithm determines if the part at the current position p(i) must be assembled before the preceding part p(j) in the sequence, either directly or indirectly, at decision diamond 84. If the current part in the sequence must be assembled before the preceding part in the sequence, then the algorithm sets pos=j at box 86. The algorithm then determines whether the preceding position is the first position in the sequence at decision diamond 88, for example, has j reached the first position. If the first position in the sequence has not been reached at the decision diamond 88, then the algorithm returns to the box 80 to look at the next preceding part in the sequence. For example, if the current position being evaluated is position 3, and the algorithm has just decided whether the part at position 3 needed to precede the part at position 2, the algorithm will then determine whether the part at position 3 needs to also precede the part at position 1.

If the algorithm has reached the first position in the sequence at the decision diamond 88, then the algorithm determines whether the part at the current position needs to be moved in the sequence at box 90, and if so, moves the part to that position in the sequence by setting part p(i) from its current position to position pos in the sequence. The algorithm then determines whether it has reached the last position N in the sequence at decision diamond 92. If the algorithm has not reached the last position in the sequence, it then returns to setting the current position to the next position in the sequence at the box 76. The algorithm continues cycling through until all of the positions have been evaluated and all the parts have been moved to satisfy their constraints.

The feasibility algorithm discussed in relation to the flow chart diagram 70 can be shown by way of example with reference to graph 24. Suppose there is a sequence (8, 9, 10, 7, 4, 6, 5, 3, 1, 2). For the first time through the loop, where the position of part 8 does not impact the assembly of part 9, no change occurs. Because part 10 need not be assembled before parts 8 or 9, it does not move either. Part 7, however, must precede both parts 8 and 10, so it moves to the first position in the sequence, yielding (7, 8, 9, 10, 4, 6, 5, 3, 1, 2). Next, because part 4 must precede part 9 in the assembly sequence, it moves to the third position, yielding (7, 8, 4, 9, 10, 6, 5, 3, 1, 2). Part 6 must be assembled before parts 7,8,9 and 10, so it must be moved to the start of the sequence, providing (6, 7, 8, 4, 9, 10, 5, 3, 1, 2). Part 5 must precede part 7, 8 and 10, so it moves to the second position in this sequence, providing (6, 5, 7, 8, 4, 9, 10, 3, 1, 2). Part 3 must be assembled before part 9, so it moves forward two positions, providing (6, 5, 7, 8, 4, 3, 9, 10, 1, 2). Part 1 does not need to precede anything, so it does not move. Finally, part 2 must precede parts 1 and 3, so it must move to the sixth position. The final sequence is (6, 5, 7, 8, 4, 2, 3, 9, 10, 1), which satisfies all precedence constraints. Note that this sequence will preserve much of the original sequence. Independent pairs of parts 9 and 10, for example, are still assembled in the same order. Note that typically, the fictitious play algorithm will rarely generate a sequence requiring as much rearranging as this one because it would be heavily penalized by the penalty functions.

The tandemness constraint of type (d), such as parts a and b must be in sequence, may be addressed by modifying the feasibility algorithm by adding additional steps and modifying existing steps as follows. If parts a and b must be in sequence, then before the step of the box 72, move whichever part appears last in the sequence to follow immediately after the other part in the pair. Then, at the step of the box 82, if either part p(i) must be assembled before part p(j) or part p(i) is part of a tandem pair with part p(i−1), and p(i−1) must be assembled before p(j), then set pos=j. Then at the step of the box 90, if part p(i) is part of a tandem pair with part p(i−1) then move part p(i−1) to position pos and part p(i) to position pos+1 from their current positions. Otherwise, if part p(i) is not part of a tandem pair with part p(i−1) then move part p(i) to position pos in the sequence from its current position.

Note that in the case of an anti-tandemness constraint of type (d) where parts i and j cannot be in sequence, then for a feasible sequence to exist in such a circumstance, it is guaranteed that there must exist some third part k that must be feasibly assembled either immediately after part i, but before part j (case 1), or immediately after part j, but before part I(case 2). Such a part may be identified by examining the matrices M for precedence constraints. Using this fact, the feasibility algorithm may be modified to address anti-tandemness constraints by adding the logic below before the first step of the box 72 in the feasibility algorithm.

For each anti-tandemness constraint of the form “parts i and j must not be in sequence” perform the following steps. Starting from the end of the sequence and working backward, consider each part i, stopping when a part k1 is identified that satisfies Case 1. If such a part i is found, consider Case 1 to be active. Starting from the end of the sequence and working backward, consider each part, stopping when a part k2 is identified that satisfies Case 2. If such a part is found, consider Case 2 to be active. If only Case 1 is active or if part i precedes part j in the sequence, then replace the original anti-tandemness constraint with the constraint that part i must precede part k1 and that part k1 must precede part j. Otherwise, replace the original anti-tandemness constraint with the constraint that part j must precede part k2 and that part k2 must precede part i.

Constraints of type (e) may often be addressed by the feasibility algorithm by applying the constraint or its contrapositive in the step of the box 82 under the assumption that parts already processed are already fixed. For example, suppose the constraint states if part i is assembled before part j, then part k must not be assembled before part m. If part m is the last of these to be processed and part i was placed before part j in the sequence, then when positioning part m, the feasibility algorithm will impose in the step of the box 82 the additional constraint that part m must precede part k. Similarly, if part j is the last to be processed and part k has already been positioned before part m, then the implied constraint that part j must be precede part i becomes active. Note that this approach will only work if adding the constraint does not yield a cyclical network in which case there is no feasibility sequence. To prevent such a scenario, it may be first examined if the network resulting from either assuming the condition and its implication are either both true or both false. If either resulting network contains a cycle, the condition can never hold, in which case the constraint is irrelevant and may be ignored.

While using large penalty functions gₘ helps ensure feasibility, this may hamper optimal convergence as changes in the objective functions are drowned out by feasibility concerns. On the other hand, too small of penalties may hinder convergence to a feasible solution. An intermediate approach is to apply the feasibility algorithm to the synthetic sequences before storing them in the database D in the step of box 48, and evaluating the resulting feasible sequence against the original objective functions in the steps of box 50. Because the solutions stored in the database D will be feasible, this may tend to reduce the burden of feasibility in the step of box 40, thus allowing the fictitious play algorithm to focus more on optimality.

Another approach is to use a sample size of 1, i.e., q=1, and replace the original objection function f with the composition of this original objective functions and the transformation described by the feasibility algorithm. By setting the sample size to 1, the algorithm is not attempting to simultaneously satisfy two different sequences. Under these circumstances, every position considered in the step of box 40 in the fictitious play algorithm will be feasible. Thus, no penalty functions are required.

Another approach for dealing with infeasibility in the step of box 40 in the fictitious play algorithm is to dynamically build up to a set of random policies in the step of box 36 of the fictitious play algorithm so that policies are not added to the sample set if their addition yields no feasible position for any single part. For example, if the sample set contains three policies, but a randomly selected fourth policy is such that there is no feasible position for some part k among the four policies, then the new policy would be rejected. Sampling could continue until the desired sample size is attained, a specific number of policies are rejected, etc. In this situation, no penalty functions would be required in the step of box 40 of the fictitious play algorithm.

Although the algorithms discussed above specifically describe the objective function f as being variation in key dimensions, the algorithms do not depend on this. The algorithms may be applied without modification to any objective functions f. The objective functions may therefore, for example, consider other factors, such as cost, cycle time, etc.

Note that although the fictitious play algorithm identifies a best assembly sequence policy p* it found according to an objective function f, these objective functions typically cannot capture the full richness of a complex decision problem. In such cases, it is also preferable to consider a set of good assembly sequence policies. The fictitious play algorithm provides such a set, namely the policies in the database D, yielding good objective values. The step of box 46 of the fictitious play algorithm may be easily modified to store both the policy p and its associated objective function A, and/or the objective function f of the sequence that results when the feasibility algorithm is applied to the policy to ensure feasibility in the database D to facilitate the identification of such good policies.

For a specific implementation of the fictitious play algorithm, the following modifications may yield improved performance. Results depend on problem specifics. Particularly, when generating random samples of past policies p, consider only the past T policies under the assumption that they are better. Further, when generating random samples of past policies, sample only from the subset of policies that have good objective functions f, either by considering some top fraction of policies or by considering only policies whose objective function f is better than a specified threshold. Also, when generating random samples of past policies, sample only from the subset of feasible or near feasible policies, for example, the policies that violate fewer than a predetermined number of constraints. Furthermore, when generating random samples of past policies, weight the probability of selecting a policy in such a manner as to favor the selection of policies that have good objective functions f and/or which are feasible or near feasible. One approach is to set the probability of a policy being selected to be inversely proportional to the objective value of the policy.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for optimizing a sequence, said sequence being a series of things, said method comprising:
assigning an agent to each thing in the sequence;
defining an objective function that is a function of a variation of the things;
determining an initial sequence of the things;
defining a random sample of past sequences of the things;
sequentially and independently selecting an optimal position in the sequence of the things that minimizes the objective function relative to sampled sequences;
determining a new sequence of the things based on the selected positions of the things in the sequence; and
determining whether the new sequence of the things is closer to optimal than previously determined sequences, and if so, using the new sequence as a new best sequence.

2. The method according to claim 1 further comprising assigning a penalty function to a thing if the agent for the thing selects a position that makes the sequence infeasible.

3. The method according to claim 1 further comprising resetting the position of two things in the sequence if their agents select the same position in the sequence so that the two things come one after the other in the sequence.

4. The method according to claim 3 further comprising shifting the sequence forward or backward if two agents select the same position in the sequence to satisfy all of the positions in the sequence.

5. The method according to claim 1 further comprising determining whether the sequence is feasible, and if not, applying a feasibility process to make the sequence feasible.

6. The method according to claim 5 wherein applying the feasibility process includes generating a series of matrices that define the relative feasible positions of the things in the sequence based on graph theory.

7. The method according to claim 6 wherein applying the feasibility process includes multiplying matrices to determine the required order of the things in the sequence based on prior predetermined constraints.

8. The method according to claim 5 wherein applying the feasibility process includes looking at each thing before a current position being processed on a sequential basis to determine whether the thing at the current position should come before any of the previous things.

9. The method according to claim 5 wherein applying the feasibility process includes determining whether any of the things must follow each other in the sequence, and if so, originally positioning the things together in the sequence.

10. The method according to claim 5 wherein applying the feasibility process includes determining whether any of the things in the sequence cannot follow one after the other, and if so, modifying the process accordingly.

11. The method according to claim 5 wherein applying the feasibility process includes modifying the feasibility process if a first thing in the sequence needs to come before a second thing in the sequence if a third thing in the sequence must or must not be before a fourth thing in the sequence.

12. The method according to claim 1 wherein the objective function is defined as variations in key dimensions.

13. The method according to claim 1 wherein the method includes employing a fictitious play algorithm.

14. The method according to claim 1 wherein the sequence is an assembly sequence.

15. The method according to claim 13 wherein the assembly sequence is an assembly of parts.

16. The method according to claim 15 wherein the parts are vehicle parts.

17. A method for optimizing a sequence, said sequence being a sequence of things, said method comprising:
defining an objective function that is a function of predetermined performance indices of the things; and
using a fictitious play algorithm for determining an optimal sequence of the things by minimizing or maximizing the objective function.

18. The method according to claim 17 wherein using a fictitious play algorithm includes assigning each thing an agent and letting each agent independently determine a position for its thing in the sequence.

19. The method according to claim 18 wherein each agent uses a random sample of past sequences of the things to determine the proper position for its thing.

20. The method according to claim 18 wherein using a fictitious play algorithm includes assigning a penalty function to a thing if the agent for the thing selects a position that makes the sequence infeasible.

21. The method according to claim 18 wherein using a fictitious play algorithm includes resetting the position of two things in the sequence if their agents select the same position in the sequence so that the two things come one after the other in the sequence.

22. The method according to claim 21 wherein using a fictitious play algorithm includes shifting the sequence forward or backward if two agents select the same position in the sequence to satisfy all of the positions in the sequence.

23. A method for optimizing an assembly sequence of parts using a fictitious play algorithm, said method comprising:
assigning an agent to each part in the sequence;
defining an objective function that is a function of a variation of the parts;
determining an initial assembly sequence of the parts;
defining a random sample of past assembly sequences of the parts;
sequentially and independently selecting an optimal position in the assembly sequence of the parts that minimizes the objective function relative to sampled assembly sequences;
assigning a penalty function to a part if the agent for the part selects a position that makes the sequence infeasible;
determining a new assembly sequence of the parts based on the selected position of the parts in the assembly sequence;
determining whether the assembly sequence is feasible, and if not, applying a feasibility process to make the sequence feasible; and
determining whether the new assembly sequence of the parts is closer to optimal than previously determined assembly sequences, and if so, using the new sequence as a new best assembly sequence.

24. The method according to claim 23 further comprising resetting the position of two things in the assembly sequence if their agents select the same position in the assembly sequence so that the two things come one after the other in the assembly sequence.

25. The method according to claim 23 further comprising shifting the assembly sequence forward or backward if two agents select the same position in the assembly sequence to satisfy all of the positions in the assembly sequence.
